(19) United States
(12) Patent Application Publication
(10) Pub. No.: US 2024/0342053 A1
(43) Pub. Date: Oct. 17, 2024

(54) EXPANSION MASSAGE DEVICE

(71) Applicant: Shenzhen Winyi Technology Co., Ltd., Shenzhen (CN)

(72) Inventors: Xinxi Li, Lianyuan (CN); Junhong Lu, Zhanjiang (CN)

(21) Appl. No.: 18/754,359

(22) Filed: Jun. 26, 2024

(30) Foreign Application Priority Data
Aug. 3, 2023 (CN) 202322068012.5

(51) Int. Cl. A61H 19/00; A61H 23/02

(52) U.S. Cl. CPC A61H 19/44; A61H 23/02; A61H 2201/1215; A61H 2201/149; A61H 2201/1654; A61H 2201/1664

(57) ABSTRACT

An expansion massage device is provided. A driving motor is used to drive a push rod to drive resisting blocks, thus jacking up massage bulges, and the massage bulges extend out of an outer surface of a massage shell to achieve a massage effect. The resisting blocks can be flexibly and controllably arranged at any position on a surface of the push rod, and the massage bulges can be flexibly and controllably arranged at any positions on the massage shell too, so that comprehensively planning the overall arrangement of the resisting blocks and the massage bulges can meet massage needs in various different modes. Compared with an existing vibration or rotation massage device, the expansion massage device has richer massage modes and a finer massage feeling, so that a user can have a better massage experience. A new simulated massage measure is provided for the field of massage apparatuses.

### TECHNICAL FIELD

The present disclosure relates to the technical field of massage apparatuses, and in particular, to an expansion massage device.

### BACKGROUND

In recent years, there has always been a strong demand trend for the sales of massagers in China, and there increasingly high requirements for massagers. Ordinary massagers are far from meeting the needs of people. Massage devices will inevitably appear in the life, improve the living health, and improve the quality of life.

The massage device is an upgraded version of the massager. It is a new generation of health care equipment developed based on the physics, the bionics, the bioelectricity, the traditional Chinese medicine, and years of clinical practice. In theory, the massage device should have a variety of simulation functions, so that a user can really experience acupuncture and moxibustion, massage, hammering, cupping, scraping, slimming, immune regulation, expelling of toxins, stress management, promotion of blood circulation, treatment of joint pain, and other functions. However, due to the limitations of a simulation technology, the massage device is far from achieving a comprehensive simulation effect in many fields. For example, a mature massage technology is mostly reflected in a few of motion modes such as translation, vibration, and rotation of a massage head, or a simple integration of the above modes. Therefore, it is difficult to achieve an ideal simulation effect. However, the maturity of the technology is not an instant process, and industry personnel need to constantly explore, research, and gradually improve it. Therefore, innovation is an unshirkable mission for industry insiders.

### SUMMARY

The present disclosure aims to provide an expansion massage device. Through an innovative structural design, the massage device can achieve expansion type massage, which provides a new simulated massage measure in the field of massage apparatuses.

To achieve the above objectives, the present disclosure provides the following technical solutions: An expansion massage device includes a massage head; the massage head includes a massage shell; a first accommodating chamber is formed in the massage shell; a through hole for extension and retraction is provided on the massage shell; the through hole for extension and retraction penetrates through the massage shell; massage bulges are slidably connected into the through hole for extension and retraction; a driving mechanism is arranged in the first accommodating chamber; the driving mechanism can drive the massage bulges to extend outwards from the through hole for extension and retraction, so that a portion of a body of each massage bulge protrudes out of an outer surface of the massage shell; the massage bulges are connected to a reset mechanism; and when the driving mechanism relieves the driving action on the massage bulges, the reset mechanism achieves that the body portion of each massage bulge protruding out of the outer surface of the massage shell retracts into the through hole for extension and retraction.

Preferably, a lower end of the massage head is connected with a base body; the driving mechanism includes a driving motor and a push rod driven by and connected to the driving motor; the push rod does rising, falling, and/or rotating motion under the driving action of the driving motor; a plurality of resisting blocks protruding out of the surface are arranged on an outer surface of the push rod; and in a motion process of the push rod, the resisting blocks intermittently resist against the massage bulges, so that the massage bulges extend towards an outer side of the through hole for extension and retraction.

Preferably, an extension and retraction mechanism is arranged between the driving motor and the push rod; the extension and retraction mechanism includes a driving motor output shaft, a guide seat, a lifting frame, and a sliding shaft; the guide seat sleeves a periphery of the output shaft and is fixedly connected to the driving motor; the lifting frame sleeves a periphery of the guide seat and is slidably connected to the guide seat; a reciprocating screw groove is provided on an outer surface of the output shaft; a wire hole is provided on the guide seat; the lifting frame is provided with a shaft hole corresponding to the wire hole; the sliding shaft includes a crescent swinging rod and a rotating shaft coaxially connected to an axial end of the swinging rod; the swinging rod is slidably connected to the reciprocating screw groove; and the rotating shaft is rotatably connected to the shaft hole through the wire hole.

Preferably, a pressing plate mounting groove is provided at a lower end of the lifting frame; the shaft hole is provided on a wall surface of the pressing plate mounting groove; and the sliding shaft is mounted in the shaft hole through a pressing plate.

Preferably, a fastening frame is provided at a lower end of the push rod; and the push rod is fixedly connected to the lifting frame through the fastening frame.

Preferably, the massage shell includes a left massage shell and a right massage shell which are connected to each other in a covered manner; the first accommodating chamber is formed between the left massage shell and the right massage shell; and a first vibration motor is mounted in the massage shell.

Preferably, the base body includes a base body shell; the base body shell includes a left base body shell and a right base body shell which are connected to each other in a covered manner; a second accommodating chamber is formed between the left base body shell and the right base body shell; a battery, a control button, a charging interface, and a circuit board assembly are mounted in the second accommodating chamber; the battery, the control button, and the charging interface are all electrically connected to the circuit board assembly; and the control button and the charging interface are both arranged in a through hole pre-provided on the base body shell.

Preferably, the reset mechanism is an elastic ring; and the elastic ring sleeves an outer side of the massage shell and is elastically connected to the massage bulges.

Preferably, the reset mechanism is a silica gel sleeve; and the silica gel sleeve is wrapped around a periphery of the massage head and is elastically connected to the massage bulges.

Preferably, a portion of a body of the silica gel sleeve extends outwards to form an auxiliary massage head; and a second vibration motor is arranged in the auxiliary massage head.

Compared with the prior art, the present disclosure has the beneficial effects below:

In the present disclosure, a driving motor is used to drive a push rod to drive resisting blocks, thus jacking up massage bulges, and the massage bulges extend out of an outer surface of a massage shell to achieve a massage effect. The resisting blocks can be flexibly and controllably arranged at any position on a surface of the push rod, and the massage bulges can be flexibly and controllably arranged at any positions on the massage shell too, so that comprehensively planning the overall arrangement of the resisting blocks and the massage bulges can meet massage needs in various different modes. Compared with an existing vibration or rotation massage device, the expansion massage device has richer massage modes and a finer massage feeling, so that a user can have a better massage experience. A new simulated massage measure is provided for the field of massage apparatuses.

### BRIEF DESCRIPTION OF THE DRAWINGS

FIG. 1 is a structural exploded diagram I of the present disclosure;

FIG. 2 is a structural exploded diagram II of the present disclosure;

FIG. 3 is a structural exploded diagram III of the present disclosure;

FIG. 4 is a three-dimensional diagram of an appearance of the present disclosure;

FIG. 5 is a schematic diagram of an assembling relationship of an extension and retraction mechanism of the present disclosure; and

FIG. 6 is a schematic structural diagram of a sliding shaft of the present disclosure.

In the drawings: 1: silica gel sleeve; 11: auxiliary massage head; 12: second vibration motor; 2: massage head; 21: massage shell; 211: left massage shell; 212: right massage shell; 213: through hole for extension and retraction; 22: first vibration motor; 23: elastic ring; 24: massage button; 25: push rod; 251: resisting block; 252: fastening frame; 26: lifting frame; 261: shaft hole; 262: pressing plate mounting groove; 263: pressing plate; 27: guide seat; 271: wire hole; 28: driving motor; 281: output shaft; 282: reciprocating screw groove; 29: sliding shaft; 291: swinging rod; 292: rotating shaft; 3: base body; 31: left base body shell; 32: right base body shell; 33: storage battery; 34: control button; 35: charging interface; and 36: circuit board assembly.

### DETAILED DESCRIPTION OF THE EMBODIMENTS

The technical solutions in the embodiments of the present disclosure are clearly and completely described below with reference to the accompanying drawings in the embodiments of the present disclosure. Apparently, the described embodiments are merely some embodiments of the present disclosure, rather than all of the embodiments. All other embodiments obtained by a person of ordinary skill in the art based on the embodiments of the present disclosure without making creative efforts shall fall within the protection scope of the present disclosure.

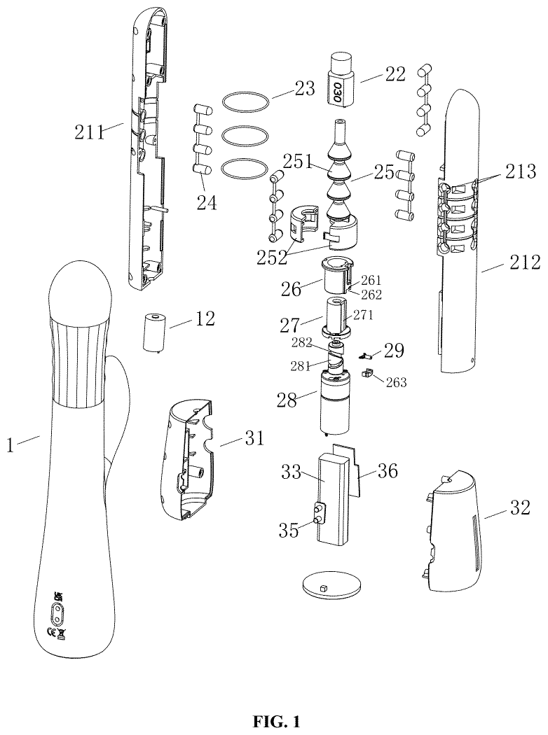

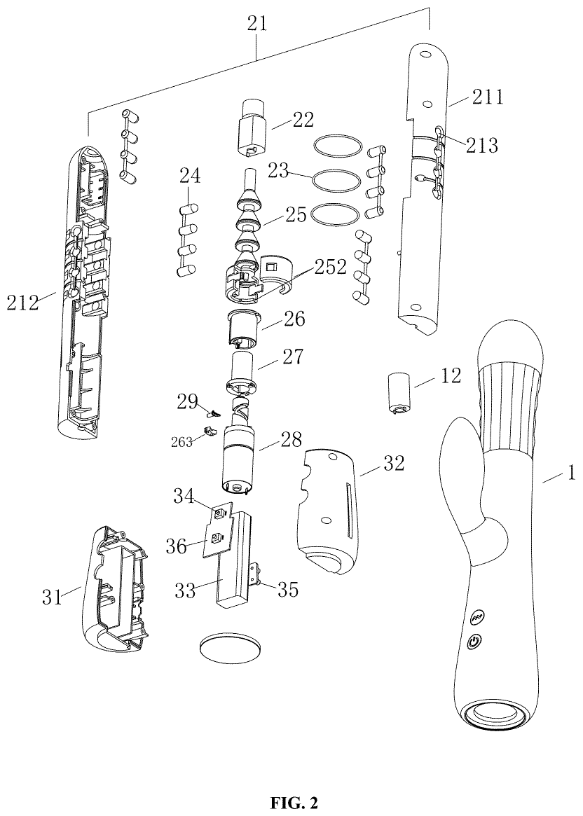

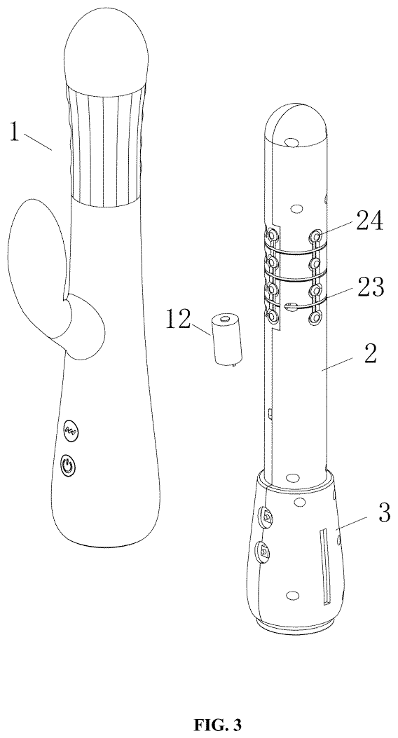

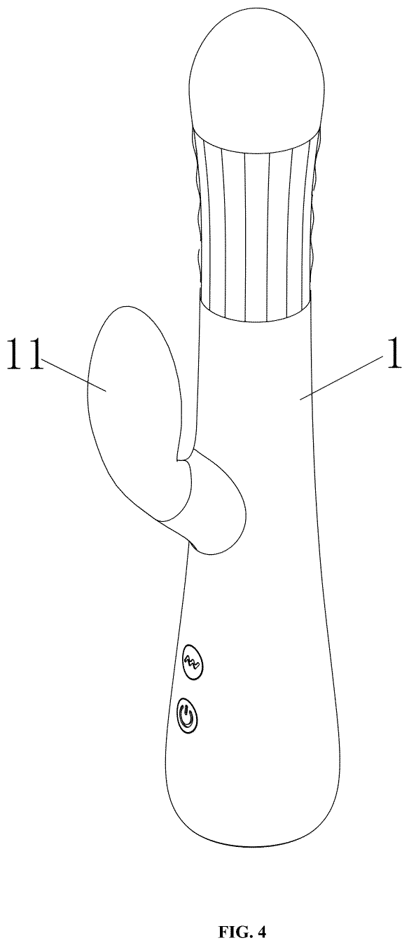

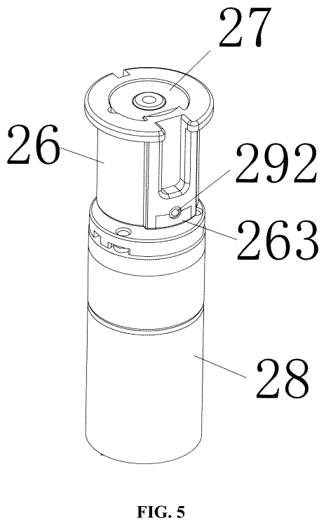

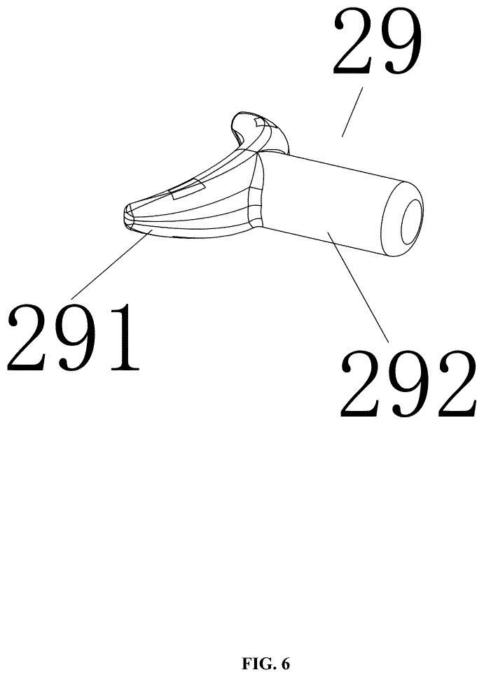

Referring to FIG. 1 to FIG. 6, an expansion massage device includes a massage head 2; the massage head 2 includes a massage shell 21; the massage shell 21 includes a left massage shell 211 and a right massage shell 212 which are connected to each other in a covered manner; a first accommodating chamber is formed between the left massage shell 211 and the right massage shell 212; a first vibration motor 22 is mounted in the massage shell 21; a through hole 213 for extension and retraction is provided on the massage shell 21; the through hole 213 for extension and retraction penetrates through the massage shell 21; massage bulges 24 are slidably connected into the through hole 213 for extension and retraction; a driving mechanism is arranged in the first accommodating chamber; the driving mechanism can drive the massage bulges 24 to extend outwards from the through hole 213 for extension and retraction, so that a portion of a body of each massage bulge 24 protrudes out of an outer surface of the massage shell 21; the massage bulges 24 are connected to a reset mechanism; and when the driving mechanism relieves the driving action on the massage bulges 24, the reset mechanism achieves that the body portion of each massage bulge 24 protruding out of the outer surface of the massage shell 21 retracts into the through hole 213 for extension and retraction. The reset mechanism is a silica gel sleeve 1; and the silica gel sleeve 1 is elastic and wrapped around a periphery of the massage head 2 and is elastically connected to the massage bulges 24. Or, the reset mechanism may be an elastic ring 23; and the elastic ring 23 sleeves an outer side of the massage shell 21 and is elastically connected to the massage bulges 24. Or, an elastic silica gel sleeve 1 and an elastic ring 23 are simultaneously used for cooperation for resetting.

Preferably, a lower end of the massage head 2 is connected with a base body 3; the driving mechanism includes a driving motor 28 and a push rod 25 driven by and connected to the driving motor 28; the push rod 25 does rising, falling, and/or rotating motion under the driving action of the driving motor 28; and a plurality of resisting blocks 251 protruding out of the surface are arranged on an outer surface of the push rod 25. In a motion process of the push rod 25, the resisting blocks 251 intermittently resist against the massage bulges 24, so that the massage bulges 24 extend towards an outer side of the through hole 213 for extension and retraction.

An extension and retraction mechanism is arranged between the driving motor 28 and the push rod 25; the extension and retraction mechanism includes a driving motor output shaft 281, a guide seat 27, a lifting frame 26, and a sliding shaft 29; the guide seat 27 sleeves a periphery of the output shaft 281 and is fixedly connected to the driving motor 28; the lifting frame 26 sleeves a periphery of the guide seat 27 and is slidably connected to the guide seat 27; a reciprocating screw groove 282 is provided on an outer surface of the output shaft 281; a wire hole 271 is provided on the guide seat 26; the lifting frame 26 is provided with a shaft hole 261 corresponding to the wire hole 271; a fastening frame 252 is provided at a lower end of the push rod 25; and the push rod 25 is fixedly connected to the lifting frame 26 through the fastening frame 252. A pressing plate mounting groove 262 is provided at a lower end of the lifting frame 26; the shaft hole 261 is provided on a wall surface of the pressing plate mounting groove 262; the sliding shaft 29 includes a crescent swinging rod 291 and a rotating shaft 292 coaxially connected to an axial end of the swinging rod 291; and the swinging rod 291 is slidably connected to the reciprocating screw groove 282. When the driving motor 28 drives the output shaft 281 to rotate, two ends of the swinging rod 291 move up and down along the reciprocating screw groove 282 under the driving of the reciprocating screw groove 282. The rotating shaft 292 penetrates through the wire hole 271, is mounted in the shaft hole 261 by using a pressing plate 263 and is rotatably connected to the shaft hole 261. When the sliding shaft 29 is driven by the reciprocating screw groove 282 to rise and fall, the lifting frame 26 is simultaneously driven by the rotating shaft 292 to rise and fall, thereby indirectly driving the push rod 25 fixedly arranged on the lifting frame 26 to move up and down.

The base body 3 includes a base body shell; the base body shell includes a left base body shell 31 and a right base body shell 32 which are connected to each other in a covered manner; a second accommodating chamber is formed between the left base body shell 31 and the right base body shell 32; a battery 33, a control button 34, a charging interface 35, and a circuit board assembly 36 are mounted in the second accommodating chamber; the battery 33, the control button 34, and the charging interface 35 are all electrically connected to the circuit board assembly 36; and the control button 34 and the charging interface 35 are both arranged in a through hole pre-provided on the base body shell. The control button 34 controls massage modes of the massage bulges 24 on the massage head 2. When the charging interface 35 is connected to an external power supply through a charging cable, the storage battery 33 can be charged to supplement electric energy. In this embodiment, the silica gel sleeve 1 is integrally wrapped around the massage head 2 and the base body 3. A portion of a body of the silica gel sleeve 1 extends outwards to form an auxiliary massage head 11; and a second vibration motor 12 is arranged in the auxiliary massage head 11. The auxiliary massage head 11 is configured to assist in massaging to improve the massage experience.

In summary, in the present disclosure, the driving motor 28 is used to drive the push rod 25 to drive the resisting blocks 251, thus jacking up the massage bulges 24, and the massage bulges extend out of the outer surface of the massage shell 21 to achieve a massage effect. The resisting blocks 251 can be flexibly and controllably arranged at any position on a surface of the push rod 25, and the massage bulges 24 can be flexibly and controllably arranged at any positions on the massage shell 21 too. Thus, comprehensively planning the overall arrangement of the resisting blocks 251 and the massage bulges 24 can meet massage needs in various different modes. Compared with an existing vibration or rotation massage device, the expansion massage device has richer massage modes and a finer massage feeling, so that a user can have a better massage experience. A new simulated massage measure is provided for the field of massage apparatuses.

It should be noted that in this document, relationship terms such as first and second are used solely to distinguish one entity or operation from another entity or operation without necessarily requiring or implying any actual such relationship or order between such entities or operations. Furthermore, the terms “include”, “including”, or any other variation thereof, are intended to encompass a non-exclusive inclusion, such that a process, method, article, or device that includes a list of elements does not include only those elements but may include other elements not explicitly listed or inherent to such process, method, article, or device.

Although the embodiments of the present disclosure have been shown and described, it can be understood by those of ordinary skill in the art that various changes, modifications, substitutions, and variations can be made to these embodiments without departing from the principle and spirit of the present disclosure. The scope of the present disclosure is defined by the accompanying claims and their equivalents.

What is claimed is:

1. An expansion massage device, comprising a massage head (2), wherein the massage head (2) comprises a massage shell (21); a first accommodating chamber is formed in the massage shell (21); a through hole (213) for extension and retraction is provided on the massage shell (21); the through hole (213) for extension and retraction penetrates through the massage shell (21); massage bulges (24) are slidably connected into the through hole (213) for extension and retraction; a driving mechanism is arranged in the first accommodating chamber; the driving mechanism is able to drive the massage bulges (24) to extend outwards from the through hole (213) for extension and retraction, so that a portion of a body of each massage bulge (24) protrudes out of an outer surface of the massage shell (21); the massage bulges (24) are connected to a reset mechanism; and when the driving mechanism relieves the driving action on the massage bulges (24), the reset mechanism achieves that the body portion of each massage bulge (24) protruding out of the outer surface of the massage shell (21) retracts into the through hole (213) for extension and retraction.

2. The expansion massage device according to claim 1, wherein a lower end of the massage head (2) is connected with a base body (3); the driving mechanism comprises a driving motor (28) and a push rod (25) driven by and connected to the driving motor (28); the push rod (25) does rising, falling, and/or rotating motion under the driving action of the driving motor (28); a plurality of resisting blocks (251) protruding out of the surface are arranged on an outer surface of the push rod (25); and in a motion process of the push rod (25), the resisting blocks (251) intermittently resist against the massage bulges (24), so that the massage bulges (24) extend towards an outer side of the through hole (213) for extension and retraction.

3. The expansion massage device according to claim 2, wherein an extension and retraction mechanism is arranged between the driving motor (28) and the push rod (25); the extension and retraction mechanism comprises a driving motor output shaft (281), a guide seat (27), a lifting frame (26), and a sliding shaft (29); the guide seat (27) sleeves a periphery of the output shaft (281) and is fixedly connected to the driving motor (28); the lifting frame (26) sleeves a periphery of the guide seat (27) and is slidably connected to the guide seat (27); a reciprocating screw groove (282) is provided on an outer surface of the output shaft (281); a wire hole (271) is provided on the guide seat (26); the lifting frame (26) is provided with a shaft hole (261) corresponding to the wire hole (271); the sliding shaft (29) comprises a crescent swinging rod (291) and a rotating shaft (292) coaxially connected to an axial end of the swinging rod (291); the swinging rod (291) is slidably connected to the reciprocating screw groove (282); and the rotating shaft (292) is rotatably connected to the shaft hole (261) through the wire hole (271).

4. The expansion massage device according to claim 3, wherein a pressing plate mounting groove (262) is provided at a lower end of the lifting frame (26); the shaft hole (261) is provided on a wall surface of the pressing plate mounting groove (262); and the sliding shaft (29) is mounted in the shaft hole (261) through a pressing plate (263).

5. The expansion massage device according to claim 3, wherein a fastening frame (252) is provided at a lower end of the push rod (25); and the push rod (25) is fixedly connected to the lifting frame (26) through the fastening frame (252).

6. The expansion massage device according to claim 1, wherein the massage shell (21) comprises a left massage shell (211) and a right massage shell (212) which are connected to each other in a covered manner; the first accommodating chamber is formed between the left massage shell (211) and the right massage shell (212); and a first vibration motor (22) is mounted in the massage shell (21).

7. The expansion massage device according to claim 2, wherein the base body (3) comprises a base body shell; the base body shell comprises a left base body shell (31) and a right base body shell (32) which are connected to each other in a covered manner; a second accommodating chamber is formed between the left base body shell (31) and the right base body shell (32); a battery (33), a control button (34), a charging interface (35), and a circuit board assembly (36) are mounted in the second accommodating chamber; the battery (33), the control button (34), and the charging interface (35) are all electrically connected to the circuit board assembly (36); and the control button (34) and the charging interface (35) are both arranged in a through hole pre-provided on the base body shell.

8. The expansion massage device according to claim 1, wherein the reset mechanism is an elastic ring (23); and the elastic ring (23) sleeves an outer side of the massage shell (21) and is elastically connected to the massage bulges (24).

9. The expansion massage device according to claim 1, wherein the reset mechanism is a silica gel sleeve (1); and the silica gel sleeve (1) is wrapped around a periphery of the massage head (2) and is elastically connected to the massage bulges (24).

10. The expansion massage device according to claim 9, wherein a portion of a body of the silica gel sleeve (1) extends outwards to form an auxiliary massage head (11); and a second vibration motor (12) is arranged in the auxiliary massage head (11).
